(19) United States
(12) Patent Application Publication
(10) Pub. No.: US 2006/0035667 A1
(43) Pub. Date: Feb. 16, 2006

(54) Multi band mobile communications terminal

(75) Inventor: Man-Soo Kim, Gyeonggi-Do (KR)

Correspondence Address: JONATHAN Y. KANG, ESQ.;LEE & HONG P.C., 14th Floor, 801 S. Figueroa Street, Los Angeles, CA, 90017-5554, US

(73) Assignee: LG Electronics Inc.

(21) Appl. No.: 11/201,246

(22) Filed: Aug. 9, 2005

(30) Foreign Application Priority Data
Aug. 10, 2004 (KR) 2004-62914

(51) Int. Cl. H04M 1/00

(52) U.S. Cl. 455/552.1; 455/550.1

(57) ABSTRACT

Provided is a multi band mobile communications terminal in which a plurality of power amplifiers used according to each band are controlled using a minimized number of control signals, whereby fabrication cost can be reduced and a General Purpose Input/Output (GPIO) port can efficiently be used, the multi band mobile communications terminal comprising: a controller for outputting transmission signals according to each band and one amplification enable signal; a plurality of power amplifiers for amplifying transmission signals according to each band, respectively; selection devices for selecting each power amplifier according to levels of the transmission signals; and a switching device for supplying a power supply voltage to each power amplifier according to the amplification enable signal, the power amplifier and the selection device being further connected whenever one transmission signal according to each band is added.

### BACKGROUND OF THE INVENTION

1. Field of the Invention

The present invention relates to a mobile communications terminal, and particularly, to a multi band mobile communications terminal capable of controlling a plurality of power amplification circuits, each of which amplifies a transmission signal according to each band, using one control signal.

2. Background of the Related Art

Recently, mobile communications terminals have used various usage frequencies of 2 GHz, 2.5 GHz, 3 GHz, and the like, by which various communication methods have been provided.

A mobile communications terminal which uses Code Division Multiple Access (CDMA) communication method among those various communication methods has a structure which can support one or more bands among a Data Communication Network (DCN) signal at 800 MHz band, a Personal Communication System (PCS) signal at 1.8 GHz band, and a PCS signal at 1.9 GHz band.

However, various mobile communication methods and increase of users' requirements have required the use of multi band mobile communications terminal capable of supporting a communication method based on a new specification as well as the existing communication methods. Researches and development therefor have been advanced.

FIG. 1 shows a partial construction of a typical mobile communications terminal of the related art.

As shown therein, a related art mobile communications terminal includes: a controller 10 for outputting transmission signals DCN and PCS according to each band, and amplification control signals PA_DCN and PA_PCS, and power amplification circuits 20 and 30 provided according to each band, for amplifying each transmission signal DCN and PCS according to the amplification control signals PA_DCN and PA_PCS. Preferably, the number of the power amplification circuits is determined according to the number of bands to be processed.

FIG. 2 is a detailed circuit view of the related art mobile communications terminal shown in FIG. 1.

As shown in FIG. 2, the controller 10 is provided with a Mobile Station Modem (MSM) for outputting the transmission signal DCN or PCS which is used for selecting a particular power amplification circuit 20 or 30 through a General Purpose Input/Output (GPIO) port according to a communication method, and the amplification control signal PA_DCN or PA_PCS which is used for enabling the selected power amplification circuit 20 or 30.

The power amplification circuits 20 and 30 are provided with three transistors 1 to 3 and one load capacitor C. The transmission signal DCN or PCS using a different band is inputted into a gate of the transistor 1, and the amplification control signal PA_DCN or PA_PCS is inputted into the transistor 3. Preferably, the transistors 1 and 3 are n-type transistors, and the transistor 2 is a p-type transistor. Preferably, the above transistors 1 to 3 may be other type transistors as well as a MOS transistor.

An operation of the related art mobile communications terminal having such construction will now be explained.

First, the MSM 10 outputs one transmission signal DCN or PCS and the amplification control signal PA_DCN or PA_PCS through each GPIO according to a communication method. For a convenient explanation in the present invention, it is assumed that a high level transmission signal PCS and a high level amplification control signal PA_PCS are outputted.

When the high level transmission signal PCS and the high level amplification control signal PA_PCS are outputted, the transistor 1 is turned on by the transmission signal PCS and thereby the power amplification circuit 20 is selected. The transistor 3 is turned on by the amplification control signal PA_PCS and thereby the power amplification circuit 20 is enabled. In this case, the transistors 1 to 3 refer to the MOS transistors.

When the transistor 3 is turned on, a ground voltage is applied to a gate of the transistor 2, and accordingly the transistor 2 is turned on. Therefore, a power supply voltage of 2.9V is transferred to a load capacitor C through the turned on transistors 1 and 2 to thusly output an amplification signal PA-P of 2.9V through an output terminal.

Similar to this, the same operation can be performed by outputting the transmission signal DCN and the amplification control signal PA_DCN, and accordingly an amplification signal PA-D of 2.9V is outputted through an output terminal.

However, in the related art mobile communications terminal, because the power amplification circuit is individually constructed according to each band, the number of devices used in the power amplification circuit is increased in proportion to the number of bands supportable in the terminal, which results in increase of fabrication cost and size of the terminal.

Furthermore, the amplification control signal for controlling the power amplification circuit is outputted from the GPIO port of the controller. If an additional power amplification circuit is required for processing transmission signals according to a greater number of bands, the GPIO port for outputting the amplification control signal must be further allocated to the additional power amplification circuit. As a result, a lack of the GPIO port causes a problem in which the terminal can not support various functions

### SUMMARY OF THE INVENTION

Therefore, an object of the present invention is to provide a multi band mobile communications terminal capable of controlling a plurality of power amplification circuits even by allocating a small number of GPIO ports.

To achieve these and other advantages and in accordance with the purpose of the present invention, as embodied and broadly described herein, there is provided a multi band mobile communications terminal comprising: a controller for outputting transmission signals according to each band and one amplification enable signal; a plurality of power amplifiers for amplifying the transmission signals according to each band, respectively; selection devices for selecting each power amplifier according to levels of the transmission signals; and a switching device for supplying a power supply voltage to each power amplifier according to the amplification enable signal.

Preferably, whenever one transmission signal according to a band is added, one amplifier and one selection device are further connected.

Preferably, the plurality of amplifiers are constructed as a plurality of first transistors each drain of which is connected to an output terminal, the selection devices are constructed as a plurality of second transistors which are connected between gates of the first transistors and a ground, respectively, so as to input transmission signals according to each band to their gates, and the switching device is constructed as a third transistor commonly connected between a power supply and sources of the first transistors.

Preferably, the first and third transistors are p-type MOS transistors, and the second transistors are n-type MOS transistors.

Preferably, whenever one transmission signal according to a band is added, a pair of the first and second transistors are further connected.

Preferably, the transmission signals are at least two or more signals among signals of a plurality of mobile communication methods which are not compatible with one another.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a partial construction of a typical mobile communications terminal of the related art;

FIG. 2 is a detailed circuit view of the mobile communications terminal shown in FIG. 1;

FIG. 3 is a block diagram showing a multi band mobile communications terminal according to the present invention; and

FIG. 4 is a detailed circuit view of a dual-band mobile communications terminal which is an example of the multi band mobile communications terminal shown in FIG. 3.

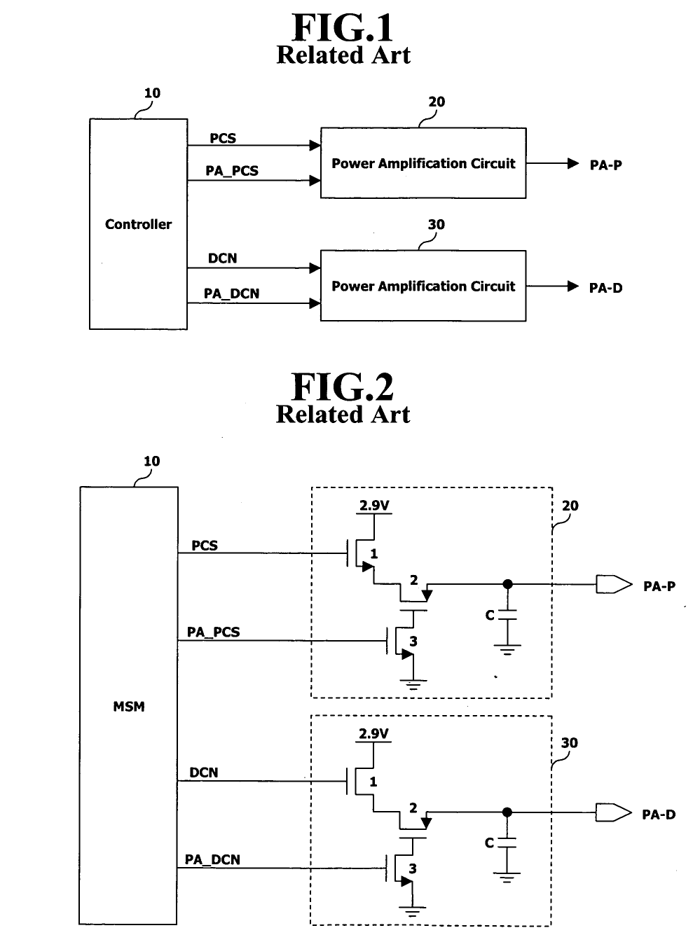

### DETAILED DESCRIPTION OF THE INVENTION

Reference will now be made in detail to the preferred embodiments of the present invention, examples of which are illustrated in the accompanying drawings.

The present invention proposes a multi band mobile communications terminal capable of synthesizing functions of a plurality power amplification circuits provided according to a band into one module and thereafter selectively controlling the corresponding module according to a communication method (according to a band). In this case, the multi band mobile communications terminal may be a dual-band mobile communications terminal which processes a DCN signal at 800 MHz and a PCS signal at 1.8 GHz. Also, the multi-band mobile communications terminal can be a triple-band terminal capable of processing the DCN signal, the PCS signal and a GPS signal, or a Dual-Band Dual-Mode (DBDM) terminal capable of processing signals based on the CDMA method (e.g., DCN signal and PCS signal) and a signal based on a Group Special Mobile (GSM) method. That is, the multi band mobile communications terminal according to the present invention can be applied to mobile communication devices (e.g., CDMA, GSM, IMT-2000, WCDMA, 3GPP, . . . ) which include a plurality of mobile communication methods which are not compatible with one another.

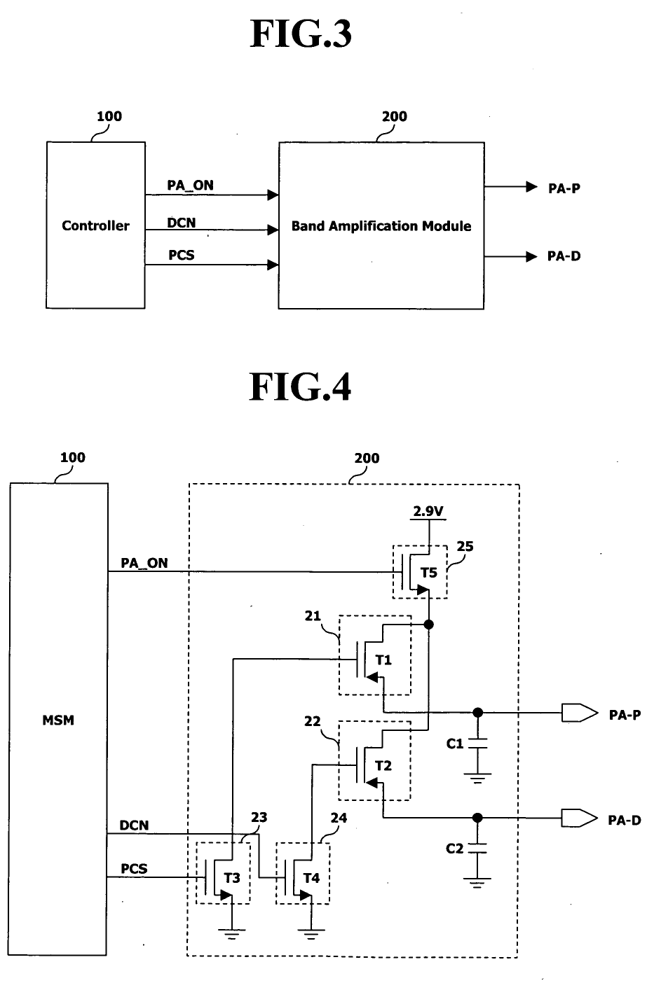

FIG. 3 is a block diagram of a multi band mobile communications terminal according to the present invention.

As shown in the drawing, a multi band mobile communications terminal according to the present invention includes: a controller 100 for outputting transmission signals DCN and PCS according to each band and an amplification control signal PA_ON; and a band amplification module 200 for amplifying the transmission signals DCN and PCS to particular levels by being enabled by the amplification control signal PA_ON outputted from the controller 100.

FIG. 4 is a detailed circuit view of a dual-band mobile communications terminal which is an example of the multi band mobile communications terminal according to the present invention shown in FIG. 3.

Referring to FIG. 4, the controller 100 includes a Mobile Station Modem (MSM) for outputting the transmission signal DCN or PCS for selecting a specific transistor 22 or 23 through a General Purpose Input/Output (GPIO) according to a communication method, and an amplification enable signal PA_ON for activating an amplification operation of the corresponding transistor 22 or 23.

The band amplification module 200 includes: power amplifiers 21 and 22 provided according to each band; selection devices 23 and 24 for selecting each power amplifier 21 and 22 according to the DCN and PCS signals; and a switching device 25 for supplying a power supply voltage of 2.9V to each power amplifier 21 and 22 according to the amplification control signal PA_ON.

Preferably, the power amplifiers 21 and 22 can be embodied as Metal Oxide Semiconductor (MOS) transistors T1 and T2, and the selection devices 23 and 24 can be embodied as MOS transistors T3 and T4 which are connected between gates of each MOS transistor T1 and T2 and a ground. The switching device 25 can be embodied as a MOS transistor T5 commonly connected between a power supply of 2.9V and sources of the MOS transistors T1 and T2. Unexplained reference symbol C denotes a load capacitor.

Preferably, the transistors T1 to T5 can be other type transistors as well as the MOS transistor. The transistors T1 and T2 correspond to p-type transistors, and the transistors T3 to T5 correspond to n-type transistors.

Therefore, when a new signal is added according to a communication method or a band to be processed, if a pair of power amplifier and selection device is further connected, the band amplification module 200 for the triple-band and the DBDM terminal can easily be embodied.

An operation of the dual-band mobile communications terminal according to the present invention having such construction will now be explained.

First, the MSM 100 outputs one transmission signal DCN or PCS and the amplification enable signal PA_ON through each GPIO according to a communication method, to thereby select one of the plurality of power amplifiers 21 and 22 which are provided according to a band. In the present invention, it is assumed that a high level transmission signal PCS and a high level amplification enable signal PA_ON are outputted so as to select the power amplifier 21.

When the high level transmission signal DCN is inputted, the MOS transistor T3, namely, the selection device 23, is turned on, by which a ground voltage is applied to a gate of the MOS transistor T1 which is the power amplifier 21, so as to turn on the power amplifier 21. As a result, the amplifier 21 of the two power amplifiers 21 and 22 is selected. Also, the MOS transistor T5 which is the switching device 25 is turned on by the high level amplification enable signal PA_ON.

When the MOS transistor T1 is turned on, because a power supply voltage of 2.9V is transferred toward a load capacitor C through the power amplifier 21, an amplification signal PA-P of 2.9V is outputted through an output terminal.

Likewise, when the high level transmission signal DCN and the high level amplification enable signal PA_ON are outputted, an amplification signal PA-D of 2.9V is outputted through an output terminal by performing the same processes as aforementioned.

As described above, in the present invention, the plurality of power amplifiers provided for amplifying transmission signals according to each band are controlled using a minimized number of control signals, which leads to decrease of fabrication cost. Also, the GPIO port can efficiently be used so as to embody multifunctional terminals.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A multi band mobile communications terminal comprising:
a controller for outputting transmission signals according to each band and one amplification enable signal; and
a band amplification module operated by the amplification enable signal, for amplifying the transmission signals according to each band to particular levels and outputting the amplified transmission signals.

2. The terminal of claim 1, wherein the controller is a mobile station modem.

3. The terminal of claim 1, wherein the transmission signals are at least two or more signals among signals of a plurality of mobile communication methods which are not compatible with one another.

4. The terminal of claim 1, wherein the band amplification module comprises:
a plurality of power amplifiers for amplifying transmission signals according to each band, respectively;
selection devices for selecting each power amplifier according to levels of the transmission signals; and
a switching device for supplying a power supply voltage to each power amplifier according to the amplification enable signal.

5. The terminal of claim 4, wherein the power amplifier and the selection device are further connected whenever one transmission signal according to a band is added.

6. The terminal of claim 1, the band amplification module comprises:
a plurality of first transistors provided according to each band and connected to an output terminal;
a plurality of second transistors connected between gates of the first transistors and a ground, respectively, and into which the transmission signal according to each band is inputted through each gate thereof; and
a third transistor commonly connected between a power supply and sources of the first transistors.

7. The terminal of claim 6, wherein the first to third transistors are Metal Oxide Semiconductor (MOS) transistors.

8. The terminal of claim 6, wherein the first and third transistors are p-type MOS transistors, and the second transistors are n-type MOS transistors.

9. The terminal of claim 6, wherein a pair of the first and second transistors are further connected whenever one transmission signal according to each band is added.

10. A multi band mobile communications terminal comprising:
a controller for outputting transmission signals according to each band and one amplification enable signal;
a plurality of power amplifiers for amplifying the transmission signals according to each band, respectively;
selection devices for selecting each power amplifier according to levels of the transmission signals; and
a switching device for supplying a power supply voltage to each power amplifier according to the amplification enable signal.

11. The terminal of claim 10, wherein one power amplifier and one selection device are further connected whenever one transmission signal according to each band is added.

12. The terminal of claim 10, wherein the plurality of power amplifiers are constructed as a plurality of first transistors each drain of which is connected to an output terminal, the selection devices are constructed as a plurality of second transistors which are connected between gates of the first transistors and a ground and into which the transmission signals according to each band are inputted through their gates, and the switching device is constructed as a third transistor commonly connected between a power supply and sources of the first transistors.

13. The terminal of claim 12, wherein the first and third transistors are p-type MOS transistors, and the second transistors are n-type MOS transistors.

14. The terminal of claim 12, wherein a pair of the first and second transistors are further connected whenever one transmission signal according to each band is added.

15. The terminal of claim 12, wherein the transmission signals are at least two or more signals among signals of a plurality of mobile communication methods which are not compatible with one another.
